(19) United States
(12) Patent Application Publication
(10) Pub. No.: US 2010/0161783 A1
(43) Pub. Date: Jun. 24, 2010

(54) SOCKET CONNECTION-BASED PRINTER DISCOVERY METHOD USING A THREAD MANAGEMENT SCHEME

(75) Inventor: Naoki KOMINE, Hawthorne, CA (US)

Correspondence Address: YING CHEN;Chen Yoshimura LLP, 255 S. GRAND AVE., # 215, LOS ANGELES, CA, 90012, US

(73) Assignee: KONICA MINOLTA SYSTEMS LABORATORY, INC., Huntington Beach, CA (US)

(21) Appl. No.: 12/338,965

(22) Filed: Dec. 18, 2008

(51) Int. Cl. G06F 15/16

(52) U.S. Cl. 709/224

(57) ABSTRACT

A targeted TCP socket connection-based printer discovery method is disclosed. It does not use network broadcasts; rather, single packets are sent to each IP address. A multi-threaded method is implemented so that each child thread attempts a TCP socket connection with one IP address, and multiple child threads executes simultaneously. If a connection is successful, the child thread records the corresponding IP address in a local record table. After all child threads exits, the parent thread examines each IP address in the local record table to determine whether the IP address is a supported printer not already in the discovered printer list, and adds the IP address to the discovered printer list if appropriate. Alternatively, the steps of determining whether the IP address is supported printer not already in the discovered printer list may be performed by the child threads.

### BACKGROUND OF THE INVENTION

1. Field of the Invention

This invention relates to a printer discovery method, and in particular, it relates to a printer discovery method using multiple threads and a thread management scheme.

2. Description of Related Art

Printer discovery is a process carried out by a computer to discover all printers connected to the computer by a network. A conventional printer discovery method uses an SNMP (Simple Network Management Protocol) broadcast-based discovery method. Using this method, the computer sends a broadcast packet out on the network and waits a fixed amount of time for a response from all devices on a given subnet. The method applies to computer and printers located within a single network subnet. Recently, however, due to security concerns, many networks restrict the use of SNMP broadcasts, effectively preventing such printer discovery method on the network.

### SUMMARY

Therefore, the present invention is directed to a printer discovery method that substantially obviates one or more of the problems due to limitations and disadvantages of the related art.

An object of the present invention is to provide a printer discovery method that does not use SNMP broadcast. Another object of the present invention is to provide a printer discovery method that is fast.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a printer discovery method implemented on a computer, the computer being connected to a plurality of printers via a network, the computer storing a discovered printer list, which includes: (a) obtaining one or more IP address ranges containing a plurality of IP addresses; (b) a parent thread spawning a child thread for each IP address within the IP address ranges; (c) each child thread attempting a TCP socket connection with the corresponding IP address within a predetermined time period, wherein at least two of the TCP socket connections are attempted concurrently; (d) the parent thread monitoring whether all child threads have exited; and (e) updating the discovered printer list in accordance with the results of the TCP socket connections attempted in step (c).

In another aspect, the present invention provides a printer discovery method implemented on a computer, the computer being connected to a plurality of printers via a network, the computer storing a discovered printer list, the method including: (a) obtaining one or more IP address ranges containing a plurality of IP addresses; (b) spawning a child thread for each IP address within the IP address ranges, each child thread attempting a TCP socket connection with the corresponding IP address and storing the IP address in a table if the connection is successful; (c) after all child threads have exited, examining each IP address in the table to determine whether a network device having the IP address is a supported printer not already in the discovered printer list, and adding the IP address to the discovered printer list if the network device having the IP address is a supported printer and is not already in the discovered printer list.

In another aspect, the present invention provides a printer discovery method implemented on a computer, the computer being connected to a plurality of printers via a network, the computer storing a discovered printer list, the method including: (a) obtaining one or more IP address ranges containing a plurality of IP addresses; (b) spawning a child thread for each IP address within the IP address ranges, each child thread performing a TCP socket connection attempt for the corresponding IP address to determine whether a network device having the IP address is a supported printer not already in the discovered printer list; and (c) monitoring whether all child threads have exited. More specifically, each child thread (1) determines whether the IP address is an active network device, (2) if it is an active network device, determines whether the IP address is already in the discovered printer list, and (3) if the IP address is not already in the discovered printer list, determines if the device is a supported printer.

In another aspect, the present invention provides computer program products that cause a computer to perform the above methods.

It is to be understood that both the foregoing general description and the following detailed description are exemplary and explanatory and are intended to provide further explanation of the invention as claimed.

### BRIEF DESCRIPTION OF THE DRAWINGS

FIGS. 1 and 2 are flow charts illustrating a printer discovery method according to a first embodiment of the present invention. FIG. 1 illustrates the process of the main routine (a parent thread) of the printer discovery process and FIG. 2 illustrates the process of a child thread spawned by the parent thread.

FIGS. 3 and 4 are flow charts illustrating a printer discovery method according to a second embodiment of the present invention. FIG. 3 illustrates the process of the main routine (a parent thread) of the printer discovery process and FIG. 4 illustrates the process of a child thread spawned by the parent thread.

FIG. 5 illustrates an environment in which embodiments of the present invention may be implemented.

### DETAILED DESCRIPTION OF PREFERRED EMBODIMENTS

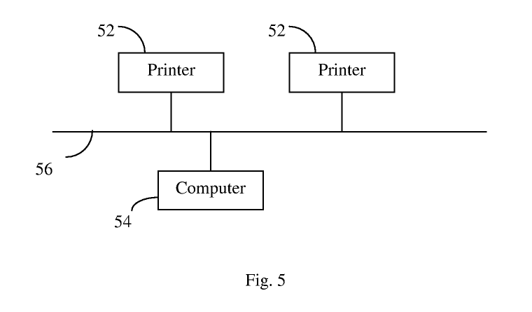

FIG. 5 illustrates an exemplary environment in which embodiments of the present invention may be implemented. In this example, a number of printers 52 and a computer (e.g. a print server or any computer that can manage or print to the printers) 54 are connected to each other via a network 56, such as a LAN (local area network), WAN (wide area network), etc. The general structures of the printers and computer are familiar to those skilled in the relevant art. Each printer 52 has an IP address, and the IP addresses of all printers 52 on the network typically fall within one or more ranges. The computer 54 carries out a printer discovery method to discover all printers on the network 56 that are supported by the computer.

Embodiments of the present invention provide a targeted TCP socket connection-based printer discovery method which does not use network broadcasts. Rather, the computer sends single packets to each IP address. A multi-threaded method is implemented to achieve a short overall time-to-completion for printer discovery, which can often be shorter than that of a SNMP-based broadcast method. In addition, unlike an SNMP-based broadcast discovery method, the printer discovery method according to embodiments of the present invention allows specific IP address targeting for faster, directed discovery of printer devices on a given network.

Socket-based communication is serial in nature. In a conventional socket-based communication method, a sender sends single packets to an IP address, waits for a response, and then repeats the process for the next IP address. Such a process is slow. In an embodiment of the present invention, a multi-threaded method is implemented so that each child thread spawn by the parent thread communicates with one target IP address, and reports back to the parent thread. Multiple child threads communicate with multiple IP addresses simultaneously.

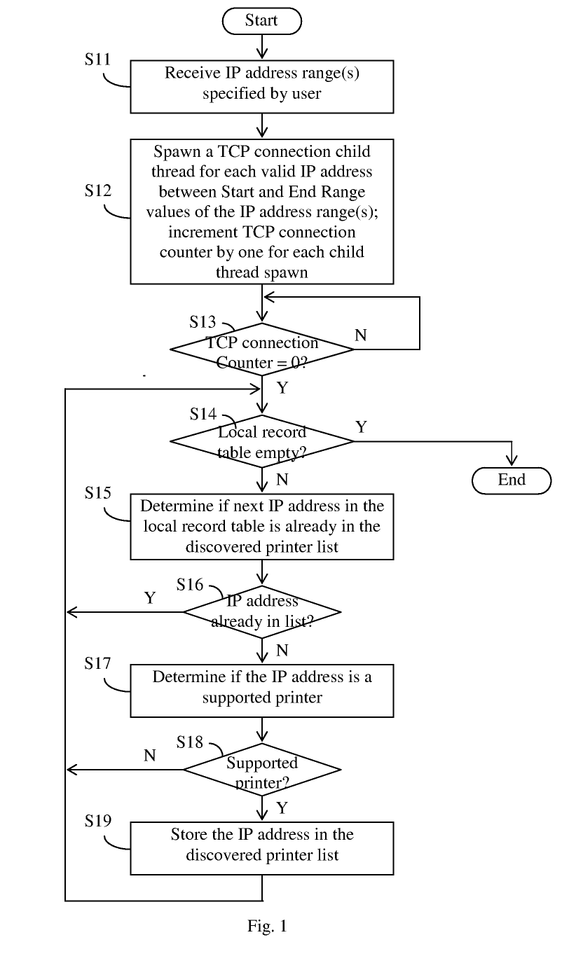

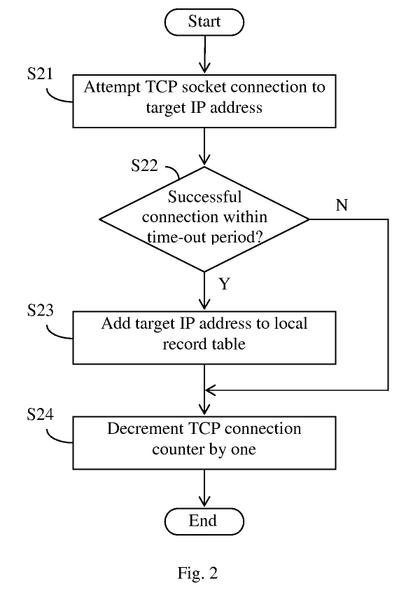

FIGS. 1 and 2 are flow charts illustrating a printer discovery method according to a first embodiment of the present invention. The method is implemented by software or firmware on a computer, such as the computer 54 in FIG. 5. FIG. 1 illustrates the process of the main routine of the printer discovery process and FIG. 2 illustrates the process of a child thread spawned by the main routine (the main routine may be referred to as the parent thread).

Referring to FIG. 1, initially, a front-end user interface module of the main routine allows the user to specify one or more IP address ranges that the user wish to conduct printer discovery on (step S11). The main routine constructs a list of all valid IP addresses within the Start and End range values of each IP address range, and spawns one TCP socket connection attempt (herein referred to as a child thread) for each IP address within the range(s) (step S12). The main routine (the parent thread) keeps track of the number of child threads (connection attempts) using a global TCP connection counter, incrementing the counter by one for each child thread spawned (see step S12). The parent thread then waits for the child threads to complete their processes.

Referring to FIG. 2, each child thread attempts a TCP socket connection to the target IP address within a pre-defined time-out period (step S21). As mentioned earlier, the child thread communicates with the target IP address by transmitting network packets to and receiving packets from that IP address. If the connection attempt is unsuccessful within the time-out period (“N” in step S22), the child thread decrements the TCP connection counter by one (step S24) and exits. The child thread may also be designed to repeat the attempt for a finite number of times. The connection attempt may be unsuccessful because, for example, there is no device present at that IP address, the other side refuses connection, or if the child thread is unable to establish a TCP socket connection with the device. The pre-defined time-out period may be, for example, 10 seconds.

If the child thread successfully makes a TCP socket connection with the target IP address within the time out period (“Y” in step S22), the child thread adds the target IP address to a local record table (step S23). The local record table is table maintained by the computer that stores IP addresses that the child threads have been able to make socket connections with. The child thread then decrements the TCP connection counter by one (step S24) and exits.

Referring back to FIG. 1, after the parent thread spawns the child threads (step S12), the parent thread continues to monitor the TCP connection counter until it reaches zero (step S13). When the counter reaches zero (“Y” in step S13), all child threads will have completed (regardless of whether the connection attempt was successful or not), and the local record table will contain all IP addresses within the IP address ranges that were connect-capable. Thereafter, the parent thread iterates through the IP addresses in the local record table to determine whether each IP address in the table is a supported printer not previously discovered.

Specifically, if the local record table is empty (“Y” in step S14), the parent thread quits the printer discovery process. If the table is not empty (“N” in step S14), the parent thread examines the next IP address in the local record table (and removes it afterwards) and determines whether that IP address already exists in the discovered printer list, which is a list maintained by the computer containing previously discovered supported printers (step S15). If it does (“Y” in step S16), that IP address is skipped and the parent thread goes back to step S14 to determine whether the local record table is empty.

If the IP address does not already exist in the discovered printer list (“N” in step S16), the parent thread determines if the device at that IP address is a supported printer (step S17). In one implementation, the parent thread issues a request to the IP address via the SNMP protocol for the sysObjectID MIB (Management Information Base) value (1.3.6.1.2.1.1.2 as defined in RFC1213-MIB). The returning MIB value is compared against a list of pre-defined supported printers' sysObjectIDs stored in the computer to see if there is a match. If there is a match, meaning the device is a supported printer (“Y” in step S18), the IP address is added to the discovered printer list for further processing (step S19), and the parent thread goes back to step S14. If the device is not a supported printer (“N” instep S18), the parent thread goes back to step S14 without adding the IP address to the discovered printer list.

Steps S15 and S16 may alternatively be performed after steps S17 and S18.

At step S14, once the local record table is empty, the parent thread will have processed all IP addresses that the child threads were able to make socket connections with, and the discovered printer list will contain the newly discovered printers within the user-specified IP address range(s) in addition to those already previously discovered. The printer discovery process concludes.

In method illustrated in FIG. 1, the parent thread waits for all child threads to exit before it starts to process the IP addressed in the local record table. Alternatively, the parent thread may start to process the IP addresses in the local record table after some child threads have exited. Logic should be implemented in the parent thread to keep track of the child threads and the parent thread's own processing of the local record table to ensure that the parent thread exits only after all child threads have completed their processing and the local record table is empty.

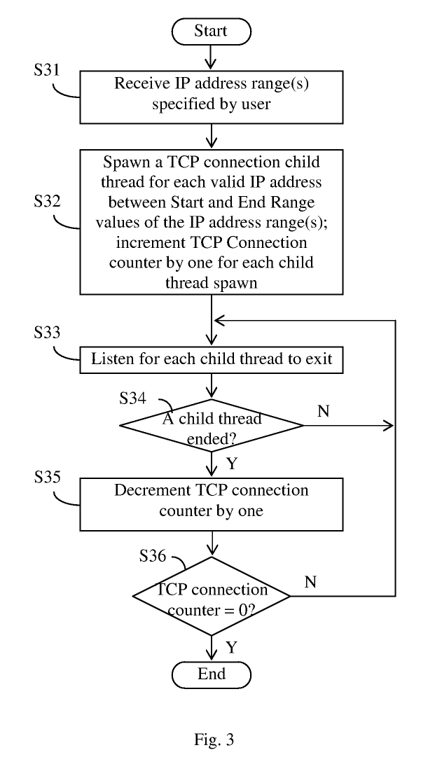

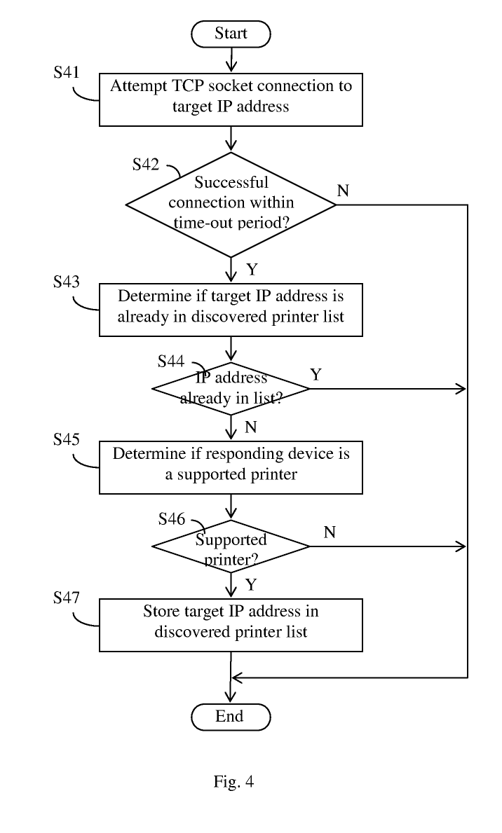

FIGS. 3 and 4 are flow charts illustrating a printer discovery method according to a second embodiment of the present invention. FIG. 3 illustrates the process of the main routine of the printer discovery process and FIG. 4 illustrates the process of a child thread spawned by the main routine (the main routine may be referred to as the parent thread). This embodiment is similar to the first embodiment, but the steps of determining whether the printer is a supported printer and whether it is already in the discovered printers list are performed by the child threads rather than the parent thread.

Referring to FIG. 3, initially, a front-end user interface module of the main routine allows the user to specify one or more IP address ranges that the user wish to conduct printer discovery on (step S31). The main routine constructs a list of all valid IP addresses within the Start and End range values of each IP address range, and spawns one TCP socket connection attempt (herein referred to as a child thread) for each IP address within the range(s) (step S32). The main routine (the parent thread) keeps track of the total number of child threads (connection attempts) using a keep-track TCP connection counter, incrementing the counter by one for each child thread spawned (see step S32).

Then, the parent thread listens for each child thread to exit (step S33). Each time a child thread exits (i.e. completes its process, whether successful or not, see below) (“Y” in step S34), the parent thread decrements the TCP connection counter by one (step S35). When the TCP connection counter reaches zero (“Y” in step S36), meaning all child threads have exited, the parent thread (the printer discovery process) ends. Otherwise (“N” in step S36), the parent thread goes back to step S33 and continues to listen for the child threads to exit.

As mentioned earlier, each child thread communicates with the corresponding IP address by transmitting network packets to and receiving packets from that IP address. Referring to FIG. 4, after a child thread starts, it makes a connection attempt to determine if the target IP address is an active network device (step S41). If the connection attempt is unsuccessful within the time-out period (“N” in step S42), i.e., if there is no device present at that IP address or if the child thread is unable to establish a TCP socket connection, the child thread exits. The child thread may also be designed to repeat the attempt for a finite number of times.

If the child thread determines within the time-out period that the target IP address is an active network device (“Y” in step S42), it checks to see if that IP address already exists in the discovered printer list, which is a list maintained by the computer that contains previously discovered supported printers (step S43). If it does (“Y” in step S44), the IP address is skipped and the child thread exits without further action. If the IP address does not already exist in the discovered printer list (“N” in step S44), the child thread determines if the network device is a supported printer (step S45). In one implementation, the child thread issues a request to that IP address via the SNMP protocol for the sysObjectID MIB (Management Information Base) value (1.3.6.1.2.1.1.2 as defined in RFC1213-MIB). The returning MIB value is then compared against a list of pre-defined supported printers' sysObjectIDs stored in the computer to see if there is a match. If it is determined that the device is a supported printer (“Y” in step S46), the target IP address is added to the discovered printer list for further processing (step S47), and the child thread exits. If the device is not a supported printer (“N” in step S26), the child thread exits without storing the target IP address.

Referring back to FIG. 3, in the parent thread, once the TCP connection counter reaches zero, the parent thread will have completed its routine and the discovered printer list will contain the newly discovered printers within the user-specified IP address range(s) in addition to those already previously discovered.

In the second embodiment shown in FIGS. 3 and 4, the steps of decrementing the TCP counter are performed by the parent thread (steps S33 to S35 in FIG. 3). In an alternative design, each child thread decrements the TCP counter by one before it exits (similar to step S24 in FIG. 2, but not shown in FIG. 4), and the parent thread will not perform steps S33 to S35.

The above described printer discovery methods may be implemented using any suitable programming language and can be implemented on computers running a variety of operating systems. Further, although in the above embodiments SNMP is used as the communication protocol, the invention is not limited to SNMP based methods, and can use other suitable communication protocols.

It will be apparent to those skilled in the art that various modification and variations can be made in the printer discovery method of the present invention without departing from the spirit or scope of the invention. Thus, it is intended that the present invention cover modifications and variations that come within the scope of the appended claims and their equivalents.

What is claimed is:

1. A printer discovery method implemented on a computer, the computer being connected to a plurality of printers via a network, the computer storing a discovered printer list, the method comprising:
(a) obtaining one or more IP address ranges containing a plurality of IP addresses;
(b) a parent thread spawning a child thread for each IP address within the IP address ranges;
(c) each child thread attempting a TCP socket connection with the corresponding IP address within a predetermined time period, wherein at least two of the TCP socket connections are attempted concurrently;
(d) the parent thread monitoring whether all child threads have exited; and
(e) updating the discovered printer list in accordance with the results of the TCP socket connections attempted in step (c).

2. The method of claim 1,
wherein, in step (c), each child thread stores the corresponding IP address in a table if the connection is successful, and
wherein, in step (e) the parent thread examines each IP address in the table to determine whether a network device having the IP address is a supported printer not already in the discovered printer list, and updates the discovered printer list if the network device having the IP address is a supported printer and is not already in the discovered printer list.

3. The method of claim 1,
wherein, in step (b), the parent thread creates a counter representing the number of the child threads spawned,
wherein, in step (c), each child thread adjusts the counter before it exits, and
wherein, in step (d), the parent thread monitors the counter to determine whether all child threads have exited.

4. The method of claim 1, wherein each child thread transmits network packets to the corresponding IP address and receives network packets from the IP address.

5. The method of claim 1, wherein each child thread exits if it fails to make a TCP socket connection with the corresponding IP address within the predetermined time period.

6. The method of claim 1, wherein in step (a), the one or more IP address ranges are received from a user.

7. The method of claim 1,
wherein, in step (c), each child thread determines whether a network device having the IP address is a supported printer not already in the discovered printer list.

8. The method of claim 7,
wherein, in step (c), each child thread (1) determines whether the IP address is an active network device, (2) if it is an active network device, determines whether the IP address is already in the discovered printer list, and (3) if the IP address is not already in the discovered printer list, determines if the device is a supported printer.

9. A printer discovery method implemented on a computer, the computer being connected to a plurality of printers via a network, the computer storing a discovered printer list, the method comprising:
(a) obtaining one or more IP address ranges containing a plurality of IP addresses;
(b) spawning a child thread for each IP address within the IP address ranges, each child thread attempting a TCP socket connection with the corresponding IP address and storing the IP address in a table if the connection is successful;
(c) examining each IP address in the table to determine whether a network device having the IP address is a supported printer not already in the discovered printer list, and adding the IP address to the discovered printer list if the network device having the IP address is a supported printer and is not already in the discovered printer list.

10. The method of claim 9,
wherein step (b) includes creating a counter representing a number of child threads spawned,
wherein each child thread adjusts the counter before it exits,
where the method further comprises, before step (c), monitoring the counter to determine whether all child threads have exited, and
wherein step (c) is performed after all child threads have exited.

11. The method of claim 9, wherein each child thread transmits network packets to the corresponding IP address and receives network packets from the IP address.

12. The method of claim 9, wherein each child thread exits if it fails to make a TCP socket connection with the corresponding IP address within a pre-defined time-out period.

13. The method of claim 9, wherein in step (a), the one or more IP address ranges are received from a user.

14. A printer discovery method implemented on a computer, the computer being connected to a plurality of printers via a network, the computer storing a discovered printer list, the method comprising:
(a) obtaining one or more IP address ranges containing a plurality of IP addresses;
(b) spawning a child thread for each IP address within the IP address ranges, each child thread performing a TCP socket connection attempt for the corresponding IP address to determine whether a network device having the IP address is a supported printer not already in the discovered printer list; and
(c) monitoring whether all child threads have exited.

15. The method of claim 14, wherein step (c) includes:
(c1) creating a counter representing a number of child threads spawned; and
(c2) adjusting the counter each time a child thread exits.

16. The method of claim 14, wherein each child thread transmits network packets to the corresponding IP address and receives network packets from the IP address.

17. The method of claim 14, wherein each child thread (1) determines whether the IP address is an active network device, (2) if it is an active network device, determines whether the IP address is already in the discovered printer list, and (3) if the IP address is not already in the discovered printer list, determines if the device is a supported printer.

18. The method of claim 17, where the child thread adds the IP address to the discovered printer list if the IP address is an active network device, is not already in the discovered printer list, and is a supported printer.

19. The method of claim 17, wherein the child thread exits if it fails to determine whether the IP address is an active network device within a pre-defined time-out period.

20. The method of claim 14, wherein in step (a), the one or more IP address ranges are received from a user.
